(19) United States
(12) Patent Application Publication
(10) Pub. No.: US 2014/0158905 A1
(43) Pub. Date: Jun. 12, 2014

(54) COMPACT UV WATER TREATMENT DEVICE FOR SPAS

(71) Applicant: CALDESSO, LLC, Lake Forrest, IL (US)

(72) Inventor: Bui Hoang, Jurupa Valley, CA (US)

(21) Appl. No.: 14/103,442

(22) Filed: Dec. 11, 2013

Related U.S. Application Data
(60) Provisional application No. 61/735,949, filed on Dec. 11, 2012.

(51) Int. Cl. C02F 1/32

(52) U.S. Cl. CPC C02F 1/32
USPC 250/435

(57) ABSTRACT

A compact UV water treatment device for spas. The device includes a reactor chamber through which the water circulates which includes a housing that receives the UV source. The housing can be a quartz tube and is protected from physical shocks by resilient members. The housing is secured within the reactor chamber via a nut assembly that does not exert force against the side walls of the housing but exerts force in the direction of the axis of the housing against a resilient and compressible seal member. The nut also has an opening that allows the UV source to be removed for replacement and a removable cap that secures the UV source within the housing.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Application No. 61/735,949 filed Dec. 11, 2012 entitled COMPACT UV WATER TREATMENT DEVICE FOR SPAS.

### BACKGROUND OF THE INVENTION

1. Field of the Invention

The present invention relates to treatment devices for water in spas and, in particular, concerns a compact ultra-violet (UV) treatment device for spas.

2. Description of the Related Art

Spas are well known systems that have a tub that contains hot water that people can sit in and enjoy. As the water is heated and is in contact with human beings, the water may become contaminated with various types of germs and bacteria. To address this issue, chemicals can be added to the spa water to kill the germs and bacteria. However, these chemicals are often not effective and can make the water harsh and irritating to the spa users.

To address this issue, there has been some attempt to provide water treatment via UV radiation. UV radiation provides UV rays that preferably kill germs and bacteria. UV treatment can be an alternative to chemical treatment or can be a supplement to chemical treatment.

UV has been used to treat water in a variety of different environments but generally the treatment systems used for spas are large and prone to breakage. Consequently, there is a need for a treatment mechanism for spas that is compact and permits easy changing of the UV tube. The system should also be robust enough so that the UV tubes are protected from breakage during installation and replacement or during ordinary maintenance of the spas.

### SUMMARY OF THE INVENTION

The aforementioned needs are satisfied by the compact UV treatment device for spas of the present invention. In one aspect, the device includes a reactor chamber that has an inlet and an outlet. A UV source is positioned inside of the reactor chamber so that water that runs through the reactor chamber is treated by the UV source. To protect the UV source, one end of the UV source is positioned so as to be supported by a shock reducing spring and can further include a cushion.

In one exemplary implementation, the shock reducing spring is positioned within a cylindrical cavity that is sized to receive a housing that contains the cylindrical UV source. The spring then supports the UV source via the housing and cushions the UV source and additional cushions can be interposed between the housing and the UV source. The housing can be made of an insulating material, such as quartz, which is also transmissive to UV light radiation.

In one exemplary implementation, the reactor chamber has a surface with a hole formed therein through which the UV source is positioned. In one implementation, the hole is aligned with the cylindrical cavity and a portion of the UV source extends outward of the reactor chamber so as to be electrically connected to the power source.

In one exemplary implementation, a quartz tube extends out of the reactor chamber and receives the UV source. In one exemplary implementation, the UV source is secured in the reactor chamber via a quartz seal compression nut that has an inner surface that is perpendicular to the axis of the UV source. A compression washer and seal ring is then interposed between the quartz tube and threading on the reaction chamber that receives the quartz seal compression nut. In this implementation, the quartz seal compression nut exerts a force along the axis of the UV source and the quartz tube as opposed to normal to this axis, thus the tendency of the UV source and quartz tube to break is reduced. The UV source may also have a cushion that is positioned proximate the interface between the UV source and the quartz tube to retain the UV source within the tube and to provide further cushioning and protection against breakage of the source.

The treatment device may also include a power source, such as electronic ballast, that is positioned away from the tube and the reactor chamber. Further, a mounting bracket may be fixed to an end of the reactor chamber and an electrical enclosure can then be formed over the bracket. The bracket and enclosure may have holes so that the lamp extends into the enclosure so that electricity can be provided to the lamp via the enclosure.

The electricity may be provided via a cord and boot assembly that fits over the end of the UV source and can retain the UV source within the quartz tube. To remove the source for replacement, the enclosure is opened, and the boot assembly is removed from the UV source. The quartz compression nut is then removed and the UV source can then be extracted.

The arrangement of the UV source within the reactor chamber results in greater protection for the UV source. The other objects and advantages of the present invention will become more apparent from the following description taken in conjunction with the accompanying drawings.

### BRIEF DESCRIPTION OF THE DRAWINGS

FIG. 1 is an assembled version of the UV treatment device for spas;

FIG. 2 is an exploded perspective view of the reactor chamber of the device of FIG. 1;

FIG. 3 is a partially cut-a-away view of the device of FIG. 1 illustrating the mounting of a UV light source in the reactor chamber;

FIG. 4 is an exploded perspective view of the device of FIG. 1;

FIG. 5 is a cross-sectional view of the device of FIG. 1; and

FIG. 6 is an exemplary interaction between the lamp and the socket that is part of the device of FIG. 1.

### DETAILED DESCRIPTION

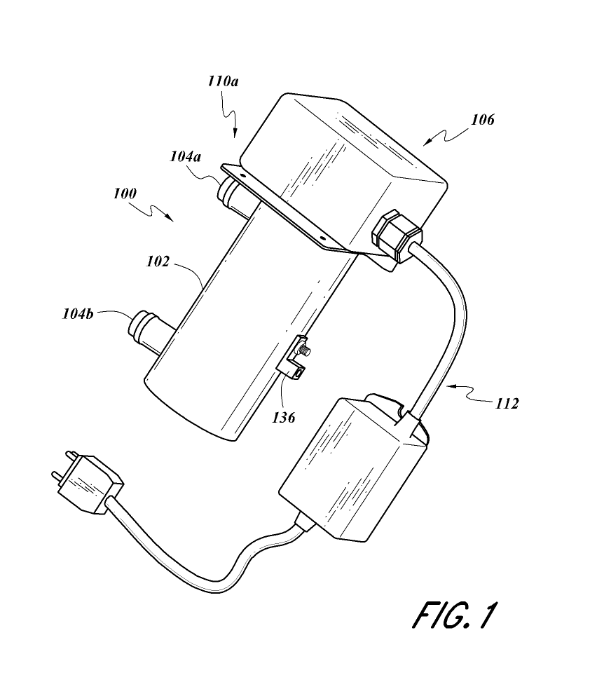

Reference will now be made to the drawings, wherein like numerals refer to like parts throughout. Referring initially to FIG. 1, an exemplary UV treatment device 100 is shown. The UV treatment device 100 includes a reactor chamber 102 that comprises a tubular structure having an inlet 104a and an outlet 104b that allows the water to be treated to flow through the reactor chamber 102 and receive UV radiation from a UV source positioned within the reactor chamber 102. The interior of the reactor chamber 102 includes a UV source that will be described in greater detail below.

As is also shown in FIG. 1, the treatment device 100 also includes a power assembly 106 that is coupled to a first end 110a of the reactor chamber 102. The power assembly 106 includes an electrical power cord 112 that provides electrical power to the UV source positioned within the reactor chamber 102 so that UV radiation can be provided to the water that is flowing through the reactor chamber 102 from the inlet 104a to the outlet 104b.

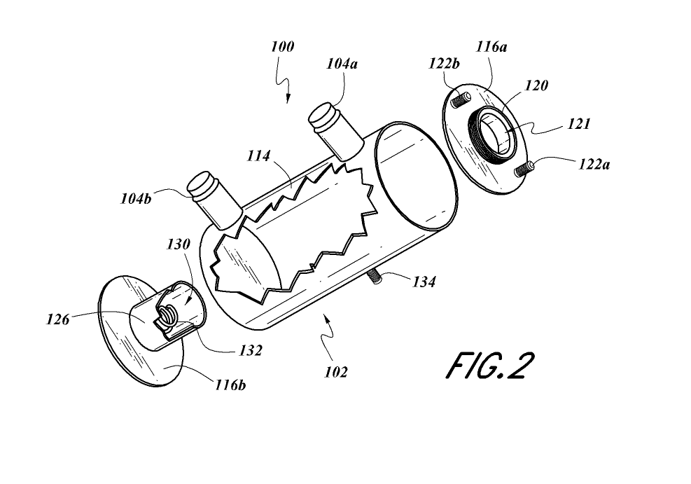

Referring now to FIG. 2, the components of the reactor chamber 102 are shown in greater detail. As shown, the reactor chamber 102 comprises a tube member 114 that, in one exemplary implementation, is 3″ in diameter by 6.5″ long and is formed of 316L Stainless Steel tubing. It will, however, be appreciated that the dimensions of the reactor chamber 102 can vary without departing from the spirit or scope of the present invention. The first and second ends, 108a, 108b are capped by end caps 116a, 116b so as to define an enclosed space for the water to flow between the inlet 104a and the outlet 104b.

The first end cap 116a includes a threaded nipple 120 that defines an opening 121. The first end cap 116a also includes two mounting studs 122a, 122b that are adapted to be coupled to the power assembly 106 as will be described in greater detail below. The second end cap 116b includes a quartz end holder 126 that defines an interior space 130 that receives an end of a UV source. The quartz end holder 126 is positioned so as to be located within the interior of the reactor chamber 102 and the quartz end holder 126 further electrically insulates the reactor chamber 102 from the UV power source. The interior space 130 of the quartz end holder includes a spring 132 that provides physical shock protection for the UV source and insulating housing in the manner that will be described in greater detail below.

The exterior of the reactor chamber 102 also includes a stud 134 that is adapted to receive a grounding lug 136 (See, FIG. 1). The grounding lug 136 allows the reactor chamber 102 to be grounded to the system ground in the event of a short circuit between the UV source and the reactor chamber 102.

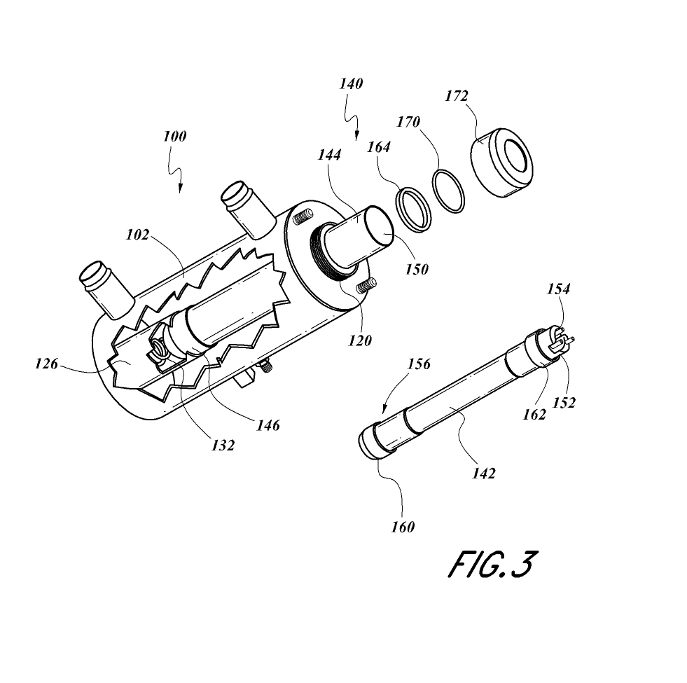

Referring to FIGS. 3-5, a mounting assembly 140 for the UV source 142 will now be described. The mounting assembly 140 includes an insulating housing that permits the transmission of UV radiation, such as a quartz tube 144, that extends through the threaded opening 121 of the nipple 120 in the first end 110a of the reactor chamber 102. A quartz tube 144 is positioned so that an end of the quartz tube 144 is positioned within the interior 130 of the quartz tube end holder 126 so as to rest upon the spring 132.

A quartz tube cushion 146 is placed around the end of the quartz tube 144 so that the quartz tube cushion 146 in conjunction with the spring 132 provides additional protection to the quartz tube 144 from breakage due to physical shock. The quartz tube cushion 146 in one exemplary embodiment comprises a cap made of a resilient and compressible material such as silicone or rubber or flexible polyolefin.

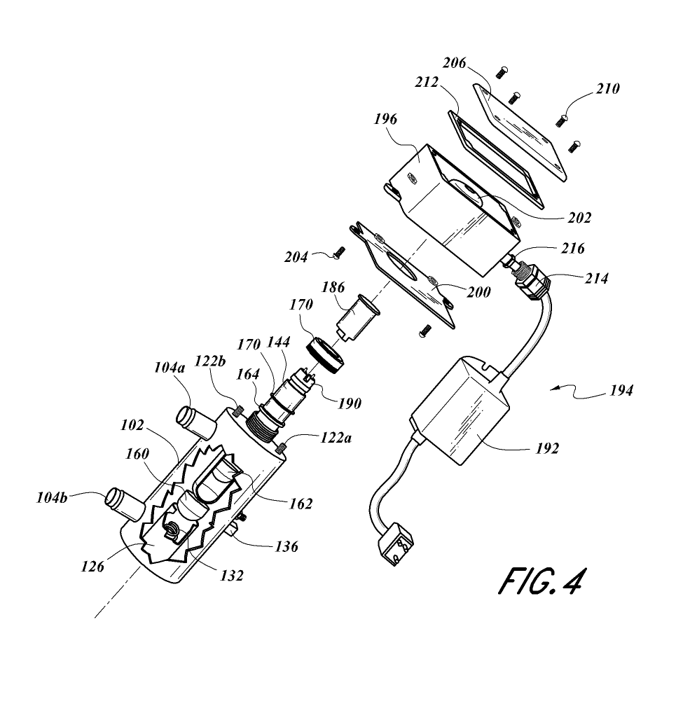

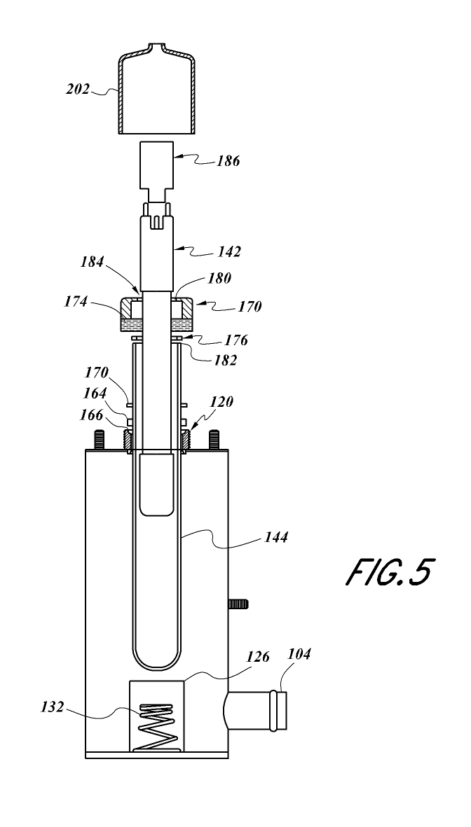

As shown in FIGS. 4 and 5, the UV source 142 is positioned within the quartz tube 144. As will be described below, the quartz tube 144 is preferably sealed so that the UV source 142 is electrically insulated from the water that is flowing through the reactor chamber 102. In one implementation, the sealing is achieved by positioning the UV source 142 within the quartz tube 144 via an opening 150 (FIG. 3) in the quartz tube 144 that has an end positioned outside of the reactor chamber 102 adjacent the first end 110a of the reactor 102. The quartz tube 144 preferably extends through the opening 121 in the threaded nipple 120. The insulating housing is selected, in this embodiment, to be a quartz tube, however any other tube that provides the same transmission ability of UV radiation and water and electrical insulation properties can also be used without departing from the scope of the present invention.

The UV source 142 can, in one implementation, comprise a UV bulb such as a 120 Volt, 6W UV bulb manufactured by Light Sources of Orange, Conn. The UV source 142 includes a connection end 152 with male terminals 154 that preferably mate with receptacles on the power supply in the manner that will be described in greater detail below. As shown in FIG. 3, opposite end 156 of the UV source 142 is preferably covered by a UV source cushion 160 that is preferably interposed between the end 156 of the UV source 142 and the inner side of the end of the quartz tube 144 that is positioned in quartz tube end holder 126. The source cushion 160 is also preferably a cap made of a resilient and compressible material such as silicone or rubber that can absorb physical forces between the light source 142 and the quartz tube 144. One or more additional cylindrical source cushions 162 may also be placed about the outer circumference of the UV source 142 so as to cushion any contact between the sides of the UV source 142 and the sides of the quartz tube 144.

FIGS. 3 through 5 illustrate the manner in which the quartz tube 144 and the UV source 142 is secured within the chamber 102. The UV source 142 is inserted into the quartz tube 144 via an opening 150. A square seal ring 164 is preferably positioned about the exposed outer end of the quartz tube 144. The square seal ring 164 is preferably made of an insulating material that is also compressible to facilitate shock absorbing and can be made of rubber, silicone or the like. The square seal ring 164 rests upon a shoulder 166 that is formed in the inner surface of the threaded opening 121.

A compression washer 170 formed of metal, such as stainless steel, is then also placed about the outer surface of the quartz tube 144. A compression nut 172 is then threaded onto the threaded nipple 120 and the compression nut 172 has a shoulder 174 that engages with the compression washer 170 to urge the square seal ring 164 against the shoulder 166 formed in the inner surface of the threaded opening 120. In this way, the quartz tube 144 is secured within the reactor chamber 102 in a water-tight fashion.

As is also shown in FIGS. 4 and 5, a washer 176 made of a compressible material such as Teflon can be interposed between an inner surface 180 of the compression nut 172 and the outer lip 182 of the quartz tube 144. This provides further protection of the quartz tube 144 from being broken when the compression nut 172 is installed. Moreover, as a result of the threaded opening 120 having the shoulder 166 and the inner surface of the compression nut 172 having the shoulder 174 (See, FIG. 5), the amount of tightening of the compression nut 172 is limited due to the interaction of these shoulders on the compression washer 170 and the seal 164. As such, the compression nut 172 is inhibited from being over tightened to where the quartz tube 144 can be damaged.

As is also shown in FIGS. 4 and 5, there is a boot member 202 that is positioned over the top of the compression nut 172 and provides electrical interconnection with the power assembly 106 in the manner that will be described in greater detail below. The boot member 202 is formed of a resilient flexible material and the boot member 202 is positioned over an opening 184 in the compression nut 172 and thereby secures the UV source 142 within the quartz tube 144.

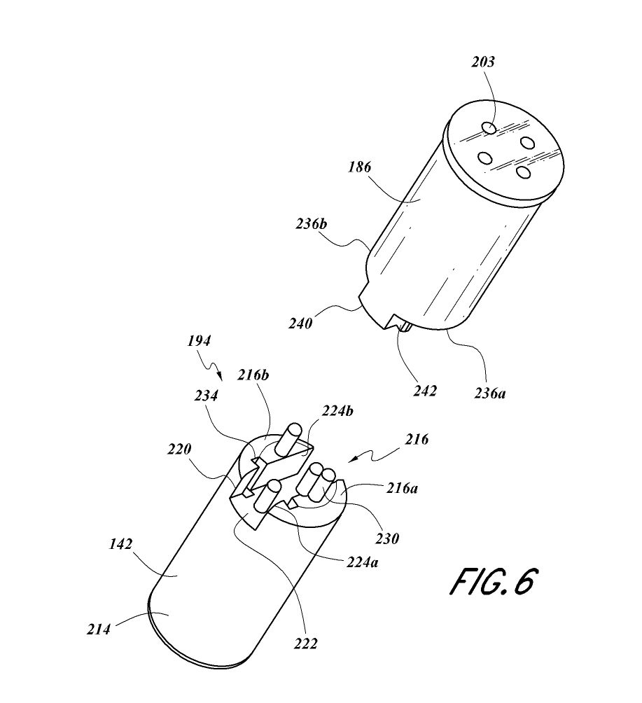

FIG. 5 further illustrates the power assembly 106. The power assembly includes a lamp socket 186 that is designed to mate with the plug end 190 of the UV source 142. The lamp socket 186 is electrically connected to a plug in an electronic ballast 192 via a cord assembly 194. As shown, the socket 186 extends into an electrical enclosure 196 though a mounting bracket 200 that engages with the mounting studs 122a, 122b. The electrical cord 194 is attached to the socket 186 via the lamp boot 202 that fits over the socket 186 and has contacts that engage with or plug into openings 203 (FIG. 6) with contacts in the socket 186. The mounting bracket 200 includes an opening that is sized to receive the compression nut 172 inside of the enclosure 196 and the mounting bracket 200 is secured to the enclosure using well known fasteners 204. Access to the interior of the enclosure 196 for replacement of the UV light source 142 is provided by an enclosure lid 206 that secured to the enclosure 196 via fasteners 210 and a gasket 212.

The cord assembly 194 may further include various strain relief devices 214, 216 that are used in a known manner. The cord assembly 194 preferably is attached to a standard electrical outlet, e.g., 120V/230V, 50 Hz/60 Hz and the ballast 192 provides the appropriate voltage and current to run the UV light source 142.

FIG. 6 illustrates a typical interconnection between the plug end 190 (See, FIG. 6) of the UV light source 142 and the socket 186. As shown, the plug end 190 of the UV light source 142 includes a lamp base 214 that has a first outer surface 216 that is comprised of two semi-hemispheric surfaces 216a, 216b. A recess 220 is formed between the two hemispheric surfaces 216a, 216b that has a bottom surface 222 and side walls 224a, 224b. As shown, one pin each 230a, 230b is formed on the two raised semi-hemispheric surfaces 216a, 216b and two pins 230c, 230d are formed on the bottom surface of the recess 220. Locking slots 234 are formed on the side walls 224a, 224b at locations that are positioned across from each other and offset from the center of the plug end 190.

The socket 186 has two recessed hemispheric surfaces 236a, 236b and a protrusion 240 that match the contour of the hemispheric raised surfaces 216a, 216b and the recess 220. Openings that receive the pins 230a, 230b, 230c, and 230d are formed in the recessed hemispheric surfaces 236a, 236b and the protrusion 240. Further, locking tabs 242 are also formed so that the socket 186 will only be used with a UV light source 142 having the matching configuration.

Advantageously, the UV source 142 can be easily replaced with less potential of breakage of the light source or the quartz tube 144. The user simply removes the enclosure lid 206 from the enclosure 196, removes the lamp boot 202 from the socket 186 and then pulls the UV light source 142 out. A new UV source 142 can then be positioned in the quartz tube 144. The spring 132 is both providing cushioning and physical shock protection but is also maintaining the quartz tube 144 and the UV source 142 at the desired height to be attached to the socket 186 in the manner described above. Further, the quartz end holder 126 also functions to center one end of the quartz tube 144 and the UV source 142 in the reactor chamber 102 and the threaded nipple 120 centers the plug end 190 of the UV light source 142.

A further advantage of the present design is that the compression nut 172 exerts force along the longitudinal direction UV light source 142 and the quartz tube 144 to secure the quartz tube 144 within the reactor chamber 102. The seal ring 164 is frictionally engaged with the outer surface of the quartz tube 144 and the seal ring 164 is secured in place by the shoulder 166 in the opening 121 of the threaded nipple 120 and the shoulder 174 (See, FIG. 5) of the compression nut 172 which limits forces exerted perpendicular to the longitudinal axis of the quartz tube 144 and thereby limits potential breakage of the quartz tube 144.

Although the foregoing discussion has shown, illustrated and described various embodiments of the present invention, it will be appreciated that various changes in the form, structure and use of the described embodiments may be made by those skilled in the art without departing from the spirit or scope of the present invention. Hence, the present invention should not be limited to the foregoing discussion, but should be defined by the appended claims.

What is claimed is:

1. A UV treatment device for treating water comprising:
a reactor chamber that has an inlet and an outlet to permit water to flow through the reactor chamber, wherein the reactor chamber defines an axis and has an opening located along the axis;
a housing having an opening positioned within the reactor chamber via the opening, wherein a portion of the housing extends outwards of the reactor chamber via the opening wherein the housing opening and the reactor opening are positioned adjacent to each other;
a UV source that is positioned within the housing wherein the housing is formed of a material that insulates the UV source from the water in the reactor and further permits transmission of UV radiation from the UV source to the water and wherein the UV source is positioned in the housing via the opening so as to extend along the axis of the reactor chamber;
an extending member that is coupled about the outer portion of the housing adjacent the opening in the reactor chamber, wherein the extending member extends outward from the housing in a direction that intersects the direction of the axis of the reactor chamber;
a securing member that couples to the extending member and the reactor chamber so as to secure the housing inside of the reactor chamber while exerting forces against the extending member in a direction that is parallel to the axis of the reactor chamber; and
a power assembly that interconnects to the UV source via the securing member to provide electricity to the UV source.

2. The device of claim 1, wherein the reactor chamber comprises a cylindrical reactor chamber having a first and second end and the housing at the first end.

3. The device of claim 2, wherein the reactor chamber is approximately 3″ in diameter and 6.5″ long.

4. The device of claim 2, wherein a second end of the reactor chamber defines an end holder that receives a distal end of the housing, wherein the end holder includes a resilient member that is interposed between the end holder and the distal end of the housing.

5. The device of claim 4, wherein the resilient member comprises a spring.

6. The device of claim 4, wherein a cushion member formed of a resilient material is further formed about the distal end of the housing.

7. The device of claim 1, wherein the housing comprises a cylindrical quartz tube.

8. The device of claim 1, wherein the UV source comprises a UV light source that is cylindrical in shape.

9. The device of claim 1, wherein the opening in the reactor chamber is formed in a threaded nipple that protrudes from an end of the reactor chamber and wherein the opening includes a shoulder that extends in a direction that intersects the axis of the reactor chamber.

10. The device of claim 9, wherein the securing member comprises a nut that threadably engages with the threaded nipple wherein the securing member includes surfaces that urge the extending member against the shoulder of the opening to secure the housing in the reactor chamber.

11. The device of claim 10, wherein the extending member comprises a first compressible washer that is positioned about the outer circumference of the housing so that the interconnection between the housing and the reactor chamber is water tight.

12. The device of claim 11, wherein the extending member further comprises a compressing washer that is interposed between the nut and the compressible washer.

13. The device of claim 9, wherein the nut comprises an opening through which the UV source is positionable into the housing.

14. The device of claim 13, further comprising a cap that is positioned about the nut to secure the UV source in the housing.

15. The device of claim 14, wherein the cap includes electrical contacts that permit the power assembly to be connected to the UV source.

16. The device of claim 15, wherein the power assembly includes an enclosure that is mounted to the first end of the reactor chamber adjacent the opening and wherein the enclosure includes an enclosure lid that is removable to permit access to the cap to facilitate replacement of the UV source.

17. The device of claim 15, wherein the cap comprises a resilient and flexible cap that is frictionally engaged with the nut to retain the UV source within the housing.

18. The device of claim 1, further comprising a socket that electrically couples the UV light source to the power assembly.
